(19) United States
(12) Patent Application Publication
(10) Pub. No.: US 2021/0316430 A1
(43) Pub. Date: Oct. 14, 2021

(54) SEAT REMOVAL TOOL

(71) Applicant: S.P.M. Flow Control, Inc., Fort Worth, TX (US)

(72) Inventors: Justin Lane POEHLS, Glen Rose, TX (US); Joel RAMIREZ, Fort Worth, TX (US); Connor Robert LANDRUM, Burleson, TX (US)

(21) Appl. No.: 17/272,402

(22) PCT Filed: Sep. 14, 2019
(86) PCT No.: PCT/US2019/051202

§ 371 Date: Mar. 1, 2021

Related U.S. Application Data
(60) Provisional application No. 62/731,762, filed on Sep. 14, 2018.

(51) Int. Cl. B25B 27/06; B25B 27/24

(52) U.S. Cl. CPC B25B 27/06; B25B 27/24

(57) ABSTRACT

A seat removal tool is disclosed for removing valve seats. A seat removal tool having a main rod, actuator rod within the main rod that actuates to cause radially expandable extraction segments to transition between an expanded position and a contracted position. When using the seat removal tool to remove a valve seat, portions of the radially expandable extraction segments may pass through a seat while the valve seat removal tool is in a contracted position. Thereafter, the seat removal tool may transition from the contracted position to an extended position, which grabs the seat. While in the expanded position, the seat removal tool may pull the valve seat from the passage.

### RELATED APPLICATIONS

This Application claims benefit from and priority to U.S. Patent Provisional Application No. 62/731,762 that was filed on Sep. 14, 2018 and that is incorporated herein by reference in its entirety.

### TECHNICAL FIELD

The present disclosure relates to removing valve seats. More specifically, and not by any way of limitation, at least some of the disclosed examples relate to a valve seat removal tool that is operable to remove valve seats.

### BACKGROUND

A reciprocating pump, particularly in the oil-and-gas space, designed for fracturing operations may be referred to as a “frac pump.” One type of frac pump is a reciprocating pump that typically includes a power end and a fluid end. The fluid end is typically formed of a single construction element or a series of elements secured together (e.g., by rods). The fluid end includes an expand for receiving a plunger or plunger throw, an inlet passage, an outlet passage, and an access port. During operation of a frac pump, fluid is pumped into the fluid end through the inlet passage and out of the pump through the outlet passage.

The inlet and outlet passages of a fluid end each include a valve assembly, which is a check type of valve that is expanded by differential pressure of the fluid and that allows the fluid to flow in only one direction. These valve assemblies typically include a valve that is movable into and out of contact with a valve seat, thereby selectively expanding and closing the valve assembly to strategically allow and halt fluid from passing therethrough. Over time, these valves and valve seats wear out or may benefit from being serviced. The most common tool currently used in the field to remove valve seats is a “duck bill” style seat puller. This conventional seat puller has two expanding segments that grab under the bottom of the seat, and typically utilizes a 2″ all thread to expand the segments. While perhaps functional, conventional seat pullers are incredibly inefficient and waste considerable—and valuable—time to retrieve valve seats, rendering fluid ends non-operational for too long.

### SUMMARY

This summary is provided to introduce a selection of concepts in a simplified form that are further described below in the Detailed Description. This summary is not intended to identify key features or essential features of the claimed subject matter. Nor is it intended to be used as an aid in determining the scope of the claimed subject matter.

A first aspect is directed to a seat removal tool. The seat removal tool system includes: an actuator; a main rod; an actuating rod positioned within the main rod and coupled to the actuator; a contracting seat puller head coupled to the actuating rod; one or more radially positioned extraction segments that are movable, through actuation of the actuator, between a contracted position and an expanded position; and a cone coupled for selectively expanding the one or more radially positioned extraction segments upon actuation of the actuator.

In some examples, a holding mechanism connects the actuating rod, the main rod, and the contracting seat puller head.

In some examples, a fastener extending through a passageway of the cone, the contracting seat puller head, and the main rod, connects to the holding mechanism.

In some examples, an inner passageway of variable circumferences operates to seat at least the main rod and the radially positioned extraction segments. In some examples, one or more springs are included.

In some examples, a ring comprising grooves and ridges mounts with opposing grooves and ridges of the one or more radially positioned extraction segments.

In some examples, at least one O-ring elastically binds at least some of the one or more radially positioned extraction segments.

In some examples, one or more threaded segments are located on an exterior portion of the main rod.

In some examples, the one or more threaded segments correspond to threads of a pancake jack.

In some examples, the expanded position is one of a plurality of expanded positions of which the one or more radially positioned extraction segments are moveable between.

In some examples, the expended position of the plurality of expanded positions is selectable.

In some examples, a modular portion comprises the contracting seat puller head, the one or more radially positioned extraction segments, and the cone, wherein the modular portion accommodates a selected range of valve seats, and wherein the modular portion is selectively attached to the main rod.

In some examples, the one or more radially positioned extraction segments are disposed in a plurality of rings, wherein a first ring is located a greater distal distance from the actuator as compared to a second ring.

In some examples, a contracted position of the first ring is narrower than a contracted position of the second ring.

In some examples, a length of the main rod and the actuating rod is modular.

Some aspects are directed to a method of removing a valve seat of a passage via a seat removal tool. In some examples, while the seat removal tool is in a contracted position, methods pass a portion of one or more radially disposed extraction segments of the seat removal tool through an axial bore of the valve seat such that the portion emerges from the axial bore.

In some examples, while the portion is emerged from the axil bore, methods transition the seat removal tool from the contracted position to an extended position, wherein the transition is caused by actuating an actuating rod that is housed within a main rod, wherein the actuation rod which pushes a head that mounts the one or more radially disposed extraction segments toward a cone over which the one or more radially disposed extraction segments slide and radially expand.

In some examples, while the seat removal tool is in the expanded position, methods pull the seated valve from the passage.

In some examples, methods transition the seat removal tool from the extended position to the contracted position, which allows the seated valve to be removed from the seat removal tool.

In some examples, methods control at least some of the passing and at least some of the pulling via a pancake jack.

Additional aspects are directed to methods of manufacturing a seat removal tool. In some examples, methods machine a passageway within a head, the passageway comprising varying circumferences operable to accomodate corresponding components securely therein.

In some examples, methods radially mount one or more elongated extraction segments within a first circumference of the passageway such that the one or more elongated extraction segments extend out from the head and over a cone.

In some examples, methods securely seat a main rod within a second circumference of the passageway.

In some examples, methods position an actuating rod within the main rod, wherein the actuating rod extends into the head.

In some examples, methods connect the head, the main rod, and the actuating rod via a holding mechanism.

In some examples, the head having the one or more elongated extraction segments mounted therein is modular, wherein a first modular head is mounted with one or more elongated extraction segments of a first length that accommodates a first range of valve seats and a second modular head is mounted with one or more elongated extraction segments of a different length that accommodates a different range of valve seats.

Other aspects, features, and advantages will become apparent from the following detailed description when taken in conjunction with the accompanying drawings, which are a part of this disclosure and which illustrate, by way of example, principles of the inventions disclosed.

### BRIEF DESCRIPTION OF THE DRAWINGS

For a more complete understanding of the present invention, reference is now made to the following descriptions taken in conjunction with the accompanying drawings, in which:

FIG. 1 is an elevational view of an example reciprocating pump assembly.

FIG. 2 is a cross-sectional view of an example fluid cylinder.

FIG. 3A is a cross-sectional view of a portion of a fluid end of an example fluid cylinder.

FIGS. 3B-3D illustrate perspective views of example seat removable tools.

FIGS. 4A-4C illustrate a perspective view and cross section views of example components of an example seat remove tool.

FIGS. 5A-5C illustrate a perspective view, front view, and cross section view of an example component of an example seat remove tool.

FIGS. 6A-6C illustrate a perspective view, top view, and cross section view of an example component of an example seat remove tool.

FIG. 7 illustrates a front view of an example component of an example seat remove tool.

FIGS. 8A-6D illustrate a perspective view, top view, and cross section view of an example component of an example seat remove tool.

FIGS. 9A-9D illustrate a perspective view, bottom view, front view, and cross section view of an example component of an example seat remove tool.

FIGS. 10A-10D illustrate a perspective view, cross section view, front view, and top view and of an example component of an example seat remove tool.

FIG. 11 illustrates a perspective exploded view of an example seat remove tool.

FIG.12 illustrates a cross section view of an example seat remove tool.

FIG. 13 is a block diagram of an example method of removing a valve seat.

FIG. 14 is a block diagram of an example method of manufacturing an example seat removal tool.

### DETAILED DESCRIPTION

Aspects of the disclosure describe examples of seat remove tools. Systems and methods disclosed herein provide solutions for aging and malfunctioning valves and valve seats by improving systems and methods for replacing and servicing valve seats. Also, some of the systems and methods disclosed herein are more user friendly and remove valve seats more efficiently, using less time as compared to conventional systems and methods (e.g., duck bill style seat pullers). For example, systems and methods disclosed herein enable quicker engagement and release of the valve seat as compared to traditional seat pullers. Further, systems and methods include multiple segments, which distribute the load more evenly thereby reducing stress experienced by the pump and the user. Additionally, example systems and methods include interchangeable heads that account for multiple seat sizes and manufacturers offering increased compatibility at a lower cost and allowing for less equipment as compared to conventional seat pullers.

Systems and methods herein significantly decrease the time involved to extract valve seats from a fluid end servicing time enabling quicker service times allowing for shorted non-operational periods. Reducing non-operational periods increases the production of systems comprising valve seats (e.g., pumps). In a frac pump example, increasing production of a frac pump increases the production rate of the frac pump thereby improving at least the operation and value of the frac pump.

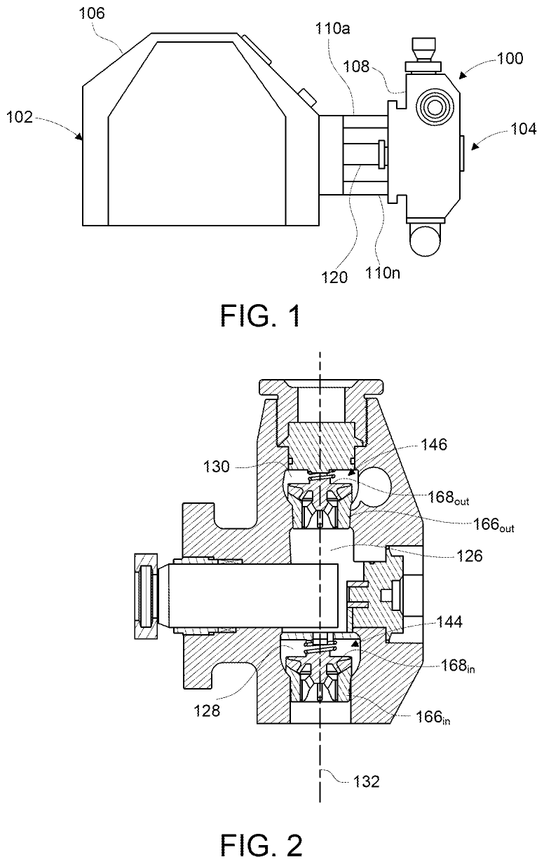

FIG. 1 is an elevational view of an example reciprocating pump assembly 100. The reciprocating pump assembly 100 includes a power end portion 102 and a fluid end portion 104 operably coupled thereto. The reciprocating pump assembly 100 may be used in various industrial applications, such as, for example but without limitation, as a hydraulic fracturing (frac) pump in the oil-and-gas industry. Other applications are also contemplated.

Looking closer at the assembly, a power end portion 102 includes a housing 106 in which a crankshaft (not shown) is disposed. The crankshaft may be driven by an engine or motor (not shown). The fluid end portion 104 may include a fluid end block or fluid cylinder 108, which is connected to housing 106 via a plurality of stay rods 110a-110n. In operation, and as discussed in further detail below, the crankshaft reciprocates a plunger rod assembly 120 between the power end portion 102 and the fluid end portion 104. According to some examples, the reciprocating pump assembly 100 may be freestanding on the ground, may be mounted to a trailer for towing between operational sites, and/or may be mounted to a movable skid.

FIG. 2 is a cross-sectional view of the fluid cylinder 108 of FIG. 1, according to one example. Specifically, the plunger rod assembly 120 includes a plunger 122 extending through a bore 124 and into a pressure chamber 126 formed in the fluid cylinder 108. At least the bore 124, the pressure chamber 126, and the plunger 122 together may be characterized as a plunger throw. According to some examples, the reciprocating pump assembly 100 includes three plunger throws (i.e., a triplex pump assembly); however, in other examples, the reciprocating pump assembly includes a greater or fewer number of plunger throws.

In the example illustrated in FIG. 2, the fluid cylinder 108 includes a fluid inlet passage 128 and a fluid outlet passage 130, both of which are formed within fluid cylinder 108. Fluid inlet passage 128 is sometimes known as a fluid suction passage 128, and fluid outlet passage 130 is sometimes known as a fluid discharge passage. Fluid inlet passage 128 and a fluid outlet passage 130 are generally coaxially disposed along a fluid passage axis 132. As described in greater detail below, fluid is adapted to flow through fluid inlet passage 128, along the fluid passage axis 132, and through a fluid outlet passage 130.

In examples, an inlet valve assembly 144 is disposed in the fluid inlet passage 128 and an outlet valve assembly 146 is disposed in the fluid outlet passage 130. Inlet value assembly 144 includes value body 168ᵢₙ and valve seat 166ᵢₙ. Outlet valve assembly 146 likewise includes value body 168ₒᵤₜ and valve seat 166ₒᵤₜ. In FIG. 2, the valve assemblies 144 and 146 are spring-loaded, which, as described in greater detail below, are actuated by at least a predetermined differential pressure across each of the valve assemblies 144 and 146. Other actuation techniques may be used, such as using hydraulics, solenoids, pressurized disks, or other mechanical or electro-mechanical components.

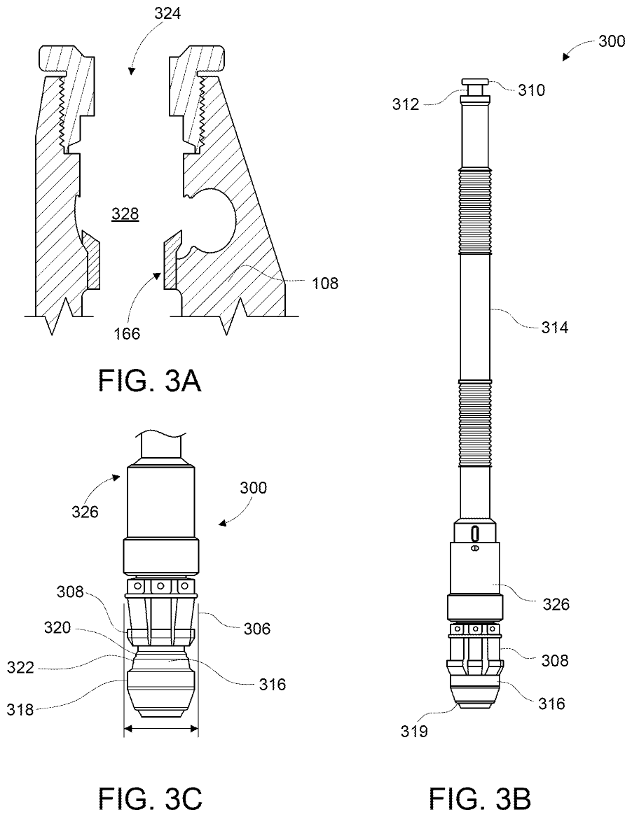

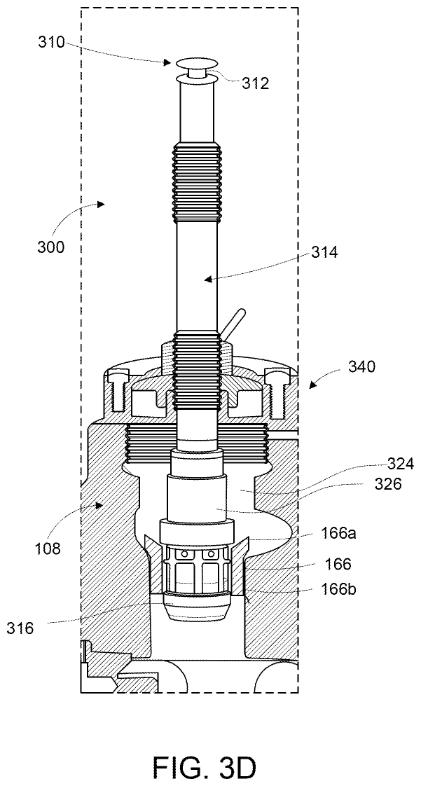

FIG. 3A is a cross-sectional view of a portion of a fluid end 104 of a fluid cylinder 108 of FIGS. 1 and 2. In this example, the plug (not shown) and the valve body (not shown) have been removed, thereby providing access to valve seat 166 via internal fluid passage 324. Valve seat 166 includes a first portion 166a, which is vertically distal from second portion 166b, and an axial bore 328 therebetween. When the valve body is seated on valve seat 166, portions of the valve body juxtapose first portion 166a and portions of the valve body are within axial bore 328. When the valve body is removed, axial bore 328 provides an opening through which portions of seat removable tools, described herein, may pass.

FIGS. 3B-3D illustrate perspective views of example seat removable tools 300. FIG. 3B shows seat removal tool 300 in an expanded position; FIG. 3C shows a portion of seat removable tools 300 in a contracted position; and FIG. 3D shows seat removable tools 300 after insertion into a fluid end 104 of a fluid cylinder 108 of FIGS. 1 and 2. FIGS. 3B-3D are described herein to provide a synopsis, and further details of example components of seat removal tool 300 are provided in following figures.

In examples, seat remove tool 300 includes main rod 314, which may include one or more treaded portions 302. Within main rod 314 is located a moveable internal actuating rod 312. An actuator 310 is connected to moveable internal actuating rod 312, such that actuating the actuator 310 selectively moves internal actuating rod 312 within the main rod 314. Actuator 310 is a mechanism that moves and controls moveable internal actuating rod 312, for example one or more of a button, spring, knob, pull, gear, lever, switch, driver, screw, bolt, wheel, and/or the like. In some examples, actuating may include one or more of spring operation, electrical actuation, pressure actuation, hydraulic actuation, or other actuation including pressing, drawing, engaging, twisting, cranking, sliding, telescoping, pushing, pulling, advancing, retracting, expanding, contracting, ascending, descending, and/or the like.

Example seat removable tools 300 may also include a movable head 326. Actuator 310 may be coupled or selectively coupled to movable head 326 via internal actuating rod 312, such that actuation of actuator 310 causes internal actuating rod 312 to move movable head 326. For example, actuation of actuator 310 may cause internal actuating rod 312 to move vertically downward away from actuator 210 and meet movable head 326 and then move moveable head 326 vertically downward from a vertically contracted position to a vertically extended position. In another example, actuation of actuator 310 may cause internal actuating rod 312 to move vertically upward toward actuator 210 and allow and/or pull moveable head 326 vertically upward from a vertically extended position to a vertically contracted position. FIG. 3B shows moveable head 326 in an example extended position and moveable head 326 in an example contracted position.

In examples, seat removable tools 300 may also include one or more moveable extraction segments 308 radially positioned around cone 316 over which moveable extraction segments 308 may move. A moveable extraction segment 308 may expand and contract radially with respect to a center point of cone 316 as the moveable extraction segment 308 moves down and over cone 316. In a contracted position, a group of one or more moveable extraction segments 308 may have a circumference that is smaller than the circumference of the same group of moveable extraction segments 308 that are in an expanded position (as shown in FIG. 3B). A ratio of a smaller circumference of the group of moveable extraction segments 308 as compared to a larger circumference of the same group may be dependent (at least partially) on an expanding diameter of cone 316. FIG. 3C shows cone 316 having tapered portions (320, 322) and base 318. First tapered portion 320 has a smaller diameter as compared to the larger diameter of tapered second portion 322. Base 318 may include a circumference that is larger than the widest portion of the tapered portions.

While in the contracted position as shown by FIG. 3C, a series of moveable extraction segments 308 may have a circumference that is small enough to allow the series of moveable extraction segments 308 to traverse a passageway and enter an area (e.g., void) that is larger than the passageway. Thereafter, moveable head 326 may move down to push one or more moveable extraction segments 308 down and over cone 316 as far as base 318.

In examples, a single radial row of radially positioned extraction segments 308 may be included, as shown in FIGS. 3B-3D. In some examples, multiple radial rows of radially positioned extraction segments 308 may be positioned vertically along seat removal tool 300, wherein the narrowest radial row of radially positioned extraction segments 308 is proximate base 318, and the other one or more radial rows of radially positioned extraction segments 308 grow progressively more broad in circumference as the row location moves vertically more distal from base 318 (or vice versa).

As shown in FIG. 3B, the shape of cone 316 causes the engaged moveable extraction segments 308 to expend radially around cone 316 as the engaged moveable extraction segments 308 are pushed down and around cone 316. In this example, while in the expanded position, some or all of the series of moveable extraction segments 308 may have a circumference that is larger than second portion 166b of valve seat 166, which prevents the series of moveable extraction segments 308 re-traversing the passageway in the opposite direction.

FIG. 3D is an example cross-sectional view of a portion of a fluid end 104 of a fluid cylinder 108 of FIGS. 1 and 2. In this example, a pancake jack 340, which includes threading that corresponds to threaded portion of seat removal tool 300, may be used to insert seat removal tool 300 into a fluid end, via internal fluid passage 324, and through axial bore 328 of valve seat 166. Seat removal tool 300 is positioned through axial bore 328 in order to, for example, retrieve valve seat 166 from fluid cylinder 108. In instances, valve seat 166 may be retrieved for replacement, for service, and/or to provide accesses to other portions of the pump.

In examples, portions of seat removal tool 300 are inserted into fluid cylinder 108 and positioned such that portions of seat removal tool 300 extend vertically distal, in a first direction, first portion 166a of valve seat 166, through and within axial bore 328 of valve seat 166, and vertically distal, in a second direction opposite the first direction, second portion 166b of valve seat 166. Said another way, in the vertical direction of the FIG. 3D, seat removal tool 300 is located above and below valve seat 166. The illustration shows some or all of portions of cone 316 are inserted through axial bore 328 and beyond second portion 166b of valve seat 166. Further, portions of one or more radially positioned extraction segments 308 are located within axial bore 328 and other portions of one or more radially positioned extraction segments 308 have been moved beyond second portion 166b of valve seat 166.

During insertion of the seat remove tool 300, a circumference of portions of some or all of the radially positioned extraction segments 308 are at or below a clearance dimension. The clearance dimension represents the diameter of inner bore of a valve seat (e.g., 2, 3, 4, 5 inches, or the like). Further, at least portions of the radially positioned extraction segments 308 that are proximate base 318 have a clearance distance at or below a clearance dimension, which allows at least these portions of the radially positioned extraction segments 308 to pass through axial bore 328 and past valve seat 166b.

After a portion of one or more radially positioned extraction segments 308 emerge from axial bore 328 past valve seat 166b, some or all the positioned extraction segments 308 transition from a contracted position to an expanded position, which is radially wider than the contracted position. The radial expansion of the radially positioned extraction segments 308 may be performed automatically (e.g., via a spring operation) and/or selectively via actuation of actuator 310. The radially expanded portions of one or more radially positioned extraction segments 308 may radially expand beyond the internal clearance dimension (e.g., diameter) of a specific valve seat 166 to be removed.

With the some or all of the radially positioned extraction segments 308 being in an expanded position, the circumference, of the portion of the expended radially positioned extraction segments 308 located past the second end 166b of valve seat 166, is wider than the circumference of second end 166b of valve seat 166. In this radially expanded position, when the seat removal tool 300 is drawn out of fluid cylinder 108, seat remove tool 300 draws valve seat 166 out of fluid cylinder 108.

The clearance dimension may vary based on the size of the valve seat, and the seat removal tool 300 may take the form of different sizes insofar as the extraction segments 308 in the contracted position may be less than or equal to the inner bore diameters of different sizes of valve seats.

Once removed, the seat removal tool 300 may be selectively actuated in the opposite way (e.g., using the actuator 310 to pull the head 326 upward into the vertically contracted position) to move the extraction segments 308 from the radially expanded position to the radially contracted position. With extraction segments 308 being in the radially contracted position, the extraction segments 308 and cone 316 may then be withdrawn from the removed valve seat 166.

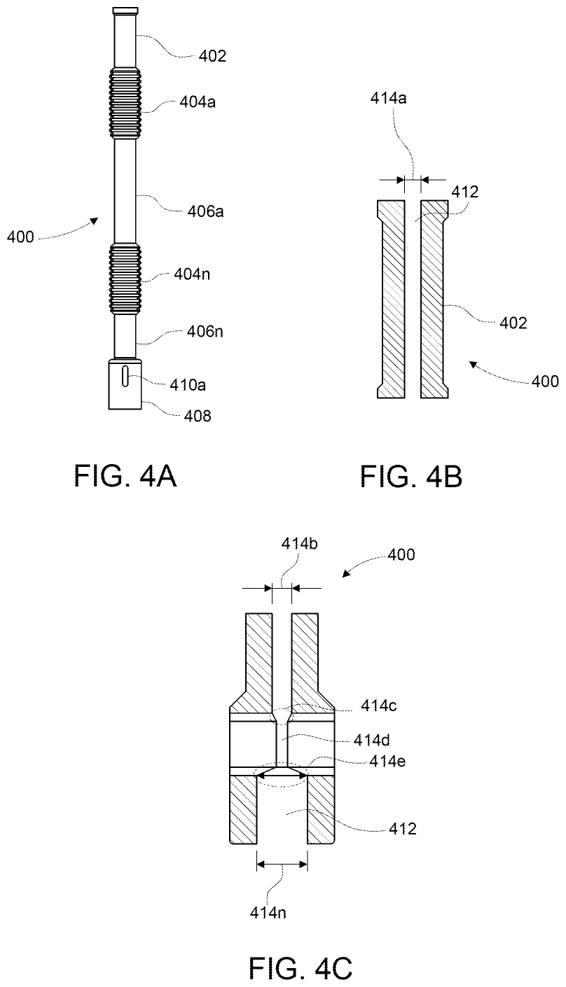

FIGS. 4A-4C show an example perspective view of main rod 400 and cross section views of portions of main rod 400 of seat remove tool 300. Main rod 400 may be an elongated shape, may be rigid, and may be made of one or more materials including, but not limited to, metal, plastic, glass, wood, rubber, foam, silicone, and/or the like. Main rod 400 may include handle 402, which may comprise the same material as other portions of the main rod (e.g., metal), and may be covered with a softer material (e.g., foam, silicone, and/or the like) to provide a comfortable grip. Handle 402 may couple to or integrates with treaded portion 404a. Threaded portion 404a may comprise a rigid material (e.g., metal, wood, plastic, and the like) that is machined according to particular threading dimensions. Main rod 400 may include a plurality of threaded portions 404a-404n, which may be machined according to same or different threading dimensions and may be separated by non-threaded portions 406a-406n of any desirable length. In examples, non-threaded portions 406a-406n may be integrated with threaded portions 404a-404n. In instances, one or more of non-threaded portions 406a-406n and threaded portions 404a-404n may be modular, such that, the length of main rod 400 may be adjustable during manufacturing and/or in the field.

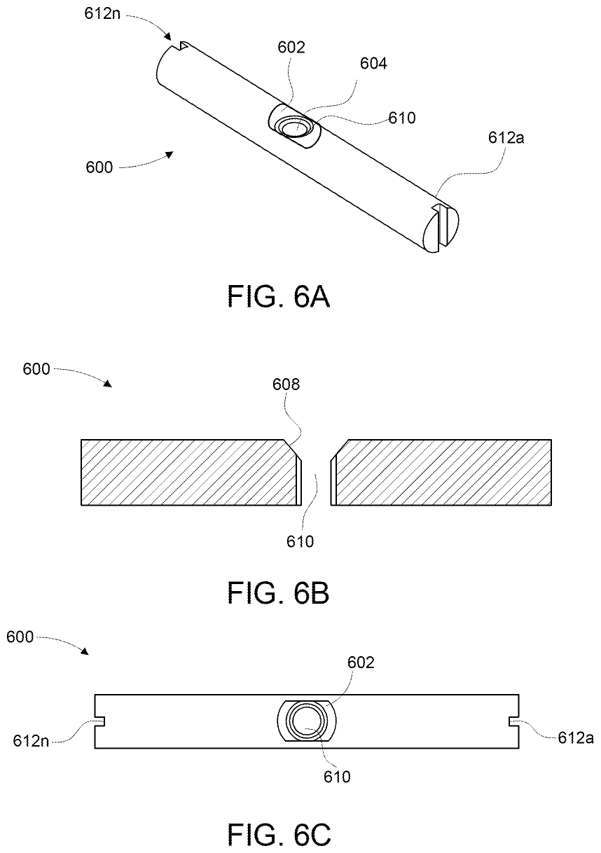

Main rod 400 may also include a coupled or an integrated attaching portion 408, which is operable to assist in attaching main rod 400 to other portions of seat removal tool 300. In examples, attaching portion 408 may attach (e.g., moveably attach) to another portion of seat removal tool 300 via one or more holding mechanisms 600 (see FIGS. 6A-6C), e.g., a pin, bolt, rod, and/or the like. In an example, attaching portion 408 may include one or more through holes 410 (e.g., slot, hole, and/or the like), which may be located on opposite sides of attaching portion 408. One or more through holes 410 may receive one or more holding mechanisms 600 therethrough. In instances, attaching portion 408 slides over (or into) another portion of seat removal tool 300 (e.g., head 326), and the one or more holding mechanisms 600 join attaching portion 408 to the other portion of seat removal tool 300 (see FIGS. 6A-6C).

Main rod 400 may include a passageway 412 that spans the entire length of main rod 400 in the elongated direction. Passageway 412 may have variable diameters, for example, the diameters of passageway 412 may be different in one or more of handle 402, threaded portion 404a, threaded portion 404n non-threaded portion 406a, non-threaded portion 406n, and attaching portion 408. For example, passageway 412 of handle 402 may have a diameter 414a, which may be different from passageway 412 of attaching portion 408, which may have variable diameters (414b-414n) therein.

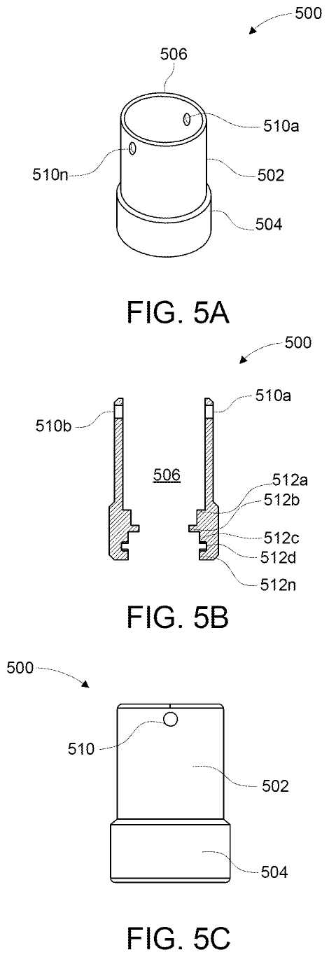

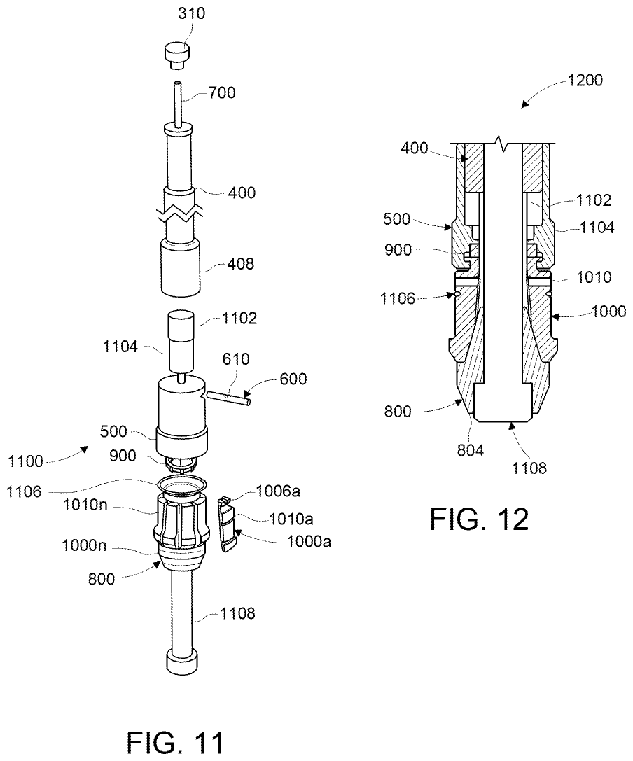

FIGS. 5A-5C illustrate an example perspective view, front view, and cross section view of head 500 of seat remove tool 300. Head 500 may attach (e.g., moveably attach) to another portion of seat removal tool 300 via one or more holding mechanisms 600 (see e.g., FIGS. 6A-6C). In an example, head 500 may include one or more through holes 510a-510n (e.g., slot, hole, and/or the like), which may be located on opposite sides of head 500. One or more through holes 510a-510n may receive one or more holding mechanisms 600 therethrough. In instances, head 500 slides over (or into) attaching portion 408, wherein through holes 510a-510n of head 500 line up with through holes 410a-410n, and the one or more holding mechanisms 600 join head 500 to attaching portion 408 (see e.g., FIG. 11).

Head 500 may be made of rigid, strong material (e.g., metal, wood, plastic, and/or the like). In examples, head 500 includes a first portion 502 and a second portion 504, and the first portion 502 may have an exterior circumference that is different from (e.g., smaller than) the exterior circumference of second portion 504. Further, head 500 may be machined to have a passageway 506 that extends through the interior of first portion 502 and second portion 504. The first portion 502 may have an interior circumference 508 sized to receive attaching portion 408 therein. One or more interior circumferences 512a-512n within second portion 504 may be different from interior circumference 508. For example, interior circumferences 512a may be narrower than interior circumference 508, such that attaching portion 408 is seated above interior circumferences 512a.

The thickness of the wall of first portion 502 may vary from second portion 504. Further, the thickness of the wall of second portion 504 may vary therein according to the varying inner circumferences 512a-512n. The plurality of inner circumferences 512a-512n may each be machined to have a shape corresponding to seat another component of seat removal tool 300 (e.g., spring 1102, bearing 1104, ring 900, extraction segments 308, etc.), which is detailed further below.

FIGS. 6A-6C illustrate an example perspective view, top view, and cross section view of holding mechanisms 600 of seat removal tool 300. Holding mechanism 600 is configured to secure a portion of seat removal tool 300 to another portion of removable tool 300, such as securing attaching portion 408 to head 500. In examples, holding mechanism 600 may be a pin, bolt, rod, and/or the like made of one or more rigid, strong materials (e.g., metal, wood, plastic, and/or the like). The surface shape of the majority of holding mechanism 600 may be cylindrical, having a static circumference along most of the shape. One or more portions of holding mechanism 600 may be a faced-off portion 602 machined to accommodate a shape of another component part of seat removal tool 300. One or more through holes 604 may be circular in shape and create a passageway 606 through holding mechanism 600. An example through hole 604 may be positioned within a faced-off portion 602, may include a tapered entrance 608, and may be threaded 610. Threaded portion 610 may be threaded according to a particular threading dimensions to allow other component parts of seat removal tool 300 to connect thereto. In examples, holding mechanism 600 may include one or more positioning portions 612a-612n, which assist in driving holding mechanism 600 into through holes (e.g., through holes 410a-410n and through holes 510a-510n). In examples, a positioning portion 612 may be a shape (e.g., line, slot, cross, star, hexagon, and/or the like) cut into one or more flat surfaces of holding mechanism 600 that is operable to receive a driving tool (e.g., screwdriver, Allen wrench, keyed wrench, and/or the like).

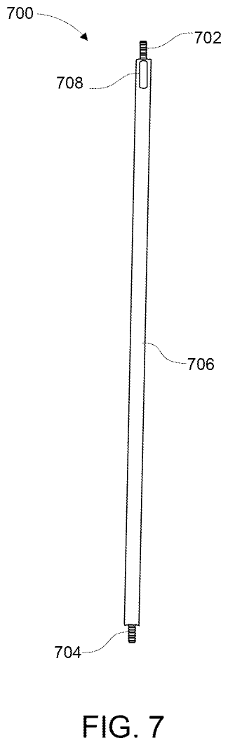

FIG. 7 illustrates a front view of actuating rod 700 (corresponding to actuator rod 312), which is housed within at least a portion of main rod 400. In examples, actuating rod 312 is elongated and is located within portions of passageway 412. Various portions of actuating rod 312 may have varying diameters. A first portion 702 of actuating rod 312 may have a first diameter and may be threaded according to particular threading dimensions. A second portion 704 that is distal first portion 702, may have a second diameter that is same or different first diameter, and may be threaded according to particular threading dimensions, which is same or different from the threading dimensions of first portion 702. A third portion 706 may have a third diameter that is same or different from first and second diameter and may connect first portion 702 and second portion 704. Actuating rod 312 may also include one or more faced-off portions 708. In examples, a faced-off portion 708 may engage with a tool (e.g., wrench).

In instances, first portion 702 may be received into and connect to an actuator 310, in examples, via threading. Further, second portion 704 may be received into and connect to holding mechanism 600 at through hole 604 via threading 610. Third diameter of third portion 706 may be sized to seat on and within faced-off portion 602 of holding mechanism 600.

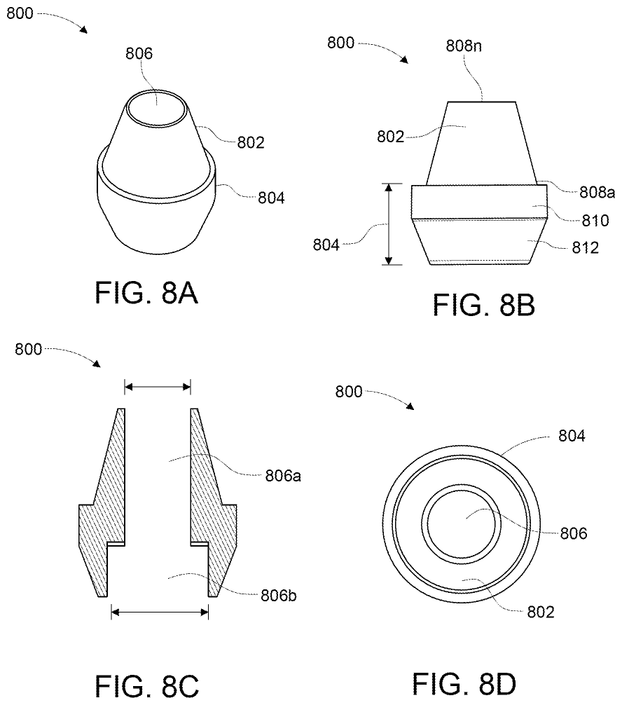

FIGS. 8A-8C illustrate an example perspective view, top view, and cross section view of cone 800, which corresponds to cone 316 of seat removal tool 300. Cone 800 may include a tapered portion 802, base 804, and passageway 806. Tapered portion 802 may have a first portion 808a proximate base 804 and a second portion 808n distal base 804. First portion 808a may have an exterior diameter that is the widest exterior diameter of tapered portion 802. The exterior diameter may taper as the first portion extends away from base 804, such that second portion 808n has an exterior diameter that is the narrowest exterior diameter of tapered portion 802.

Base 804 may be integrated with tapered portion 802 and may be made of the same one or more rigid, strong materials (e.g., metal, wood, plastic, and/or the like). Base 804 may include a first portion 810 that is proximate first portion 808a, and first portion 810 may have an exterior diameter that is wider, same, and/or narrower than first portion 808a. In some examples, base 804 may also include second portion 812 having an exterior diameter that tapers as second portion 812 extends away from first portion 808a.

Cone 800 may be machined to have a passageway 806 (e.g., having portions of variable circumferences 806a-806n) that extends through the interior of tapered portion 802 and base 804. In examples, the inner circumference of tapered portion 802 may be static, and the thickness of the walls of tapered portion 802 may be variable according to the tapering angle of tapered portion 802. Further, the inner circumference of base 804 may be variable, and the thickness of the walls of base 804 may be variable according to the tapering angle of second portion 812 and the variable inner circumference of base 804.

Passageway 806 may be machined to correspond to the shape of another component of seat removal tool 300, for example, fastener 1108 of FIGS. 11-12. In examples, a fastener is configured to connect two or more component parts of seat removal tool 300. Example fasteners include, but are not limited to, screws, bolts, pins, rods, and the like. In instances, passageway portion 806b is machined to have a shape that receives the head of a corresponding fastener, and passageway portion 806a is machined to have a circumference wide enough to allow an extended portion of the fastener to pass therethrough.

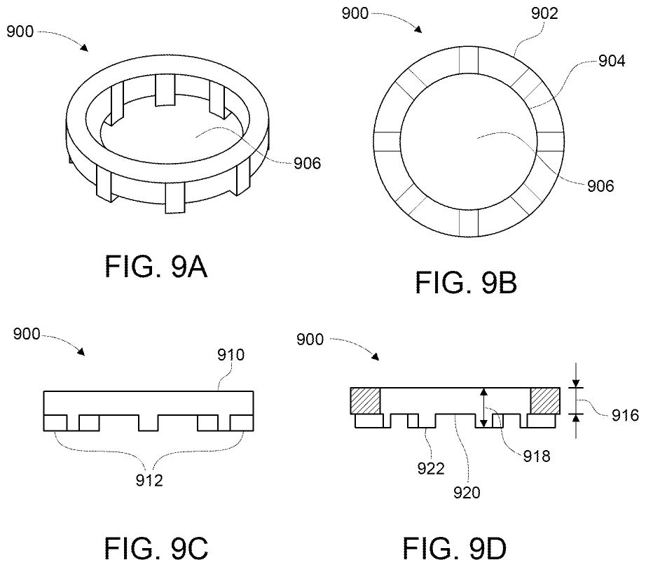

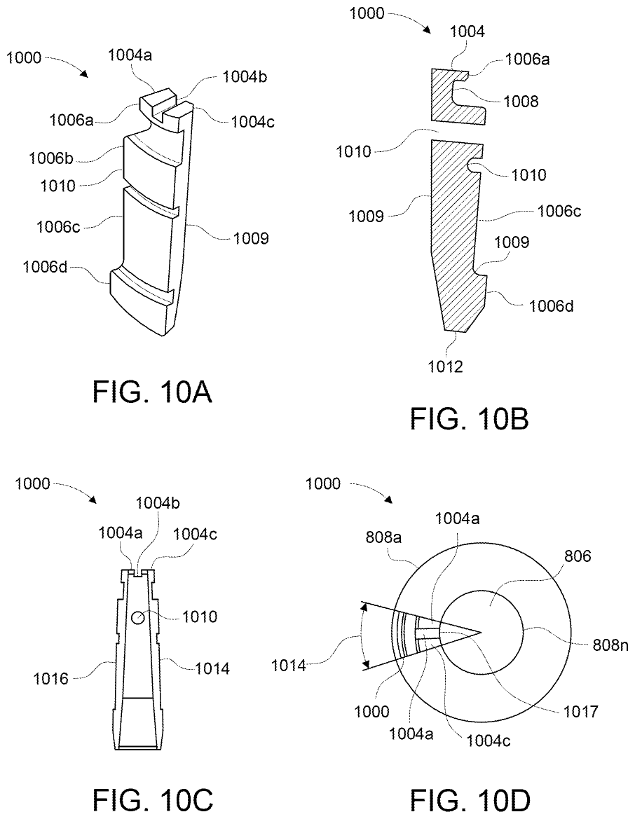

FIGS. 9A-9D illustrate an example perspective view, bottom view, front view, and cross section view of ring 900 of seat removal tool 300. Ring 900 may be made of one or more rigid and strong material (e.g., metal, wood, plastic, and/or the like). In examples, ring 900 may include a static (within tolerance) exterior circumference 902 that is larger than a static (within tolerance) interior circumference 904, which defines the diameter of passageway 906. In examples, first face 910 may have a flat surface (within tolerance), and second face 912, which is opposite first face 910, may have a variable surface, such that a first thickness 916 between first face 910 and second face 912 is thinner than second thickness 918. In examples, the rising and falling edge of ridge portion 922 may be perpendicular (within tolerance) to groove portion 920. In some examples, second face 912 of a groove portion 920 may be parallel (within tolerance) to ridge portion 922. In instances, ring 900 may be sized such that exterior circumference 902 fits within one of the inner circumferences 512a-512n of head 500 of FIG. 5C, for example, inner circumference 512c. Further, a ridge portion 922 may be sized to correspond with a groove portion of another component part of seat removal tool 300 (e.g., groove portion 1004b of extraction segment 1000 of FIGS. 10A and 10C-10D)

FIGS. 10A-10D illustrate an example perspective view, cross section view, front view, and top view and of extraction segment 1000, which corresponds to an extraction segment 308 of seat removal tool 300. Extraction segment 1000 may be made of one or more rigid and strong material (e.g., metal, wood, plastic, and/or the like). In examples, extraction segment 1000 includes an upward facing surface 1004, outward facing surface 1006, inward facing surface 1008, base surface 1012, side facing surface 1014, and opposite side facing surface 1016. Upward facing surface 1004 may have a variable surface, having a cut groove 1004b between ridges 1004a and 1004c. In examples, upward facing ridges 1004a and 1004c may have a planar surface that is parallel (within tolerance) to a planar surface of upward facing groove 1004b. In some examples, the falling and rising edges of groove 1004b may be perpendicular (within tolerance) to the planar surface of upward ridges 1004a and 1004c. Further, upper portion 1006a of outward facing surface 1006 may have a first thickness, corresponding to ridges 1004a and 1004c, which is thicker than a second thickness, corresponding to groove 1004b. In examples, upward facing groove 1004b may be sized to receive ridge portion 922 of ring 900 (see e.g., FIGS. 9A-9D and 11) therein.

Extending away from upper portion 1006a, outward facing surface 1006 of extraction segment 1000 may include second portion 1006b, third portion 1006c, and forth portion 1006d, respectively. In examples, one or more of portions 1006a-1006d may include one or more through holes 1010. In some examples, the one or more outward facing portions 1006a-1006d may be separated by one or more grooves 1008 and 1010 and/or one or more ledges 1009.

FIG. IOD illustrates an example of extraction segment 1000 from a top view and shows upward facing planar surfaces 1004a and 1004c of outward facing upper portion 1006a having a first radial width 1012 that grows radially wider as extraction segment 1000 extends away from outward facing first portion 1006a toward base 1012 of outward facing forth portion 1006d, which has a second radial width 1014. In examples, extraction segment 1000 may shaped to fit over a cone, for example, tapered portion 802 of cone 800 having a widest exterior diameter at second portion 808a that tapers as tapered portion 802 extended away from second portion 808a to the narrowest exterior diameter at second portion 808n, which surrounds passageway 806.

In instances (e.g., the examples illustrated in FIGS. 3B-3C), a plurality of extraction segments 1000 may be radially positioned around tapered portion 802 of cone 800. In such instances, side facing surface 1014 juxtaposes a side facing surface of adjacent extraction segment, and opposite side facing surface 1016 juxtaposes a side facing surface of another adjacent extraction segment. In examples, outward facing first portion 1006a and groove 1008 may be shaped and sized to correspond with two of the inner circumferences 512a-512n of head 500 of FIG. 5C, for example, inner circumferences 512d and 512n, such that outward facing second portion 1006b extends out from head 500.

FIGS. 11-12 illustrate a perspective exploded view and a cross section view of seat removal tool 1100, which corresponds to seat removal tool 300. Reference numbers of FIGS. 11-12 may correspond to one or more of FIGS. 3B, 3D, 4A-4C, 5A-5C 6A-6C 7, 8A-8D, 9A-9D, and 10A-10D.

Example seat removal tool 1100 includes an actuator 310 that is coupled (e.g., via threading) to actuating rod 700. Actuating rod 700 is located within main rod 400, which includes integrated attaching portion 408 located distal actuator 300. Attaching portion 408 is seated within head 500, and the through holes thereof are lined up with one another. Holding mechanisms 600 is inserted into a first set of through holes (e.g., a through hole of attaching portion 408 that is lined up with a through hole of head 500) and emerges at a second set of through holes (e.g., a corresponding through hole of attaching portion 408 that is lined up with a through hole of head 500). Holding mechanisms 600 couples attaching portion 408 and head 500. Within attaching portion 408, which is located within head 500, a distal portion (not shown) of actuating rod 700 couples with holding mechanism 600, for example, via a threaded distal end (not shown) of actuating rod 700 that twists into a threaded passageway 610 of holding mechanism 600.

Located within head 500 may be bearing 1104 over which spring 1102 is located. Spring 1102 may be operable to assist movement of head 500 and other component parts (e.g., ring 900 and extraction segments 1000a-1000n) and bearing 1104 may be operable to assist the operation of spring 1102.

Also located within head 500 is ring 900 and upper portions 1006a of a plurality of extraction segments 1000a-1000n. Ring 900 may be positioned such that a ridge portion 922 seats within a groove of upper portion 1006a of a corresponding extraction segment 1000. A passageway inside head 500 may be machined to have variable circumferences that correspond to the exterior diameter of component parts located within head 500, such that component parts are seated securely in place within head 500 (e.g., attaching portion 408, bearing 1104 and spring 1102, ring 900, and upper portions 1006a of a plurality of extraction segments 1000a-1000n).

Portions of extraction segments 1000a-1000n extend out from head 500 and are radially positioned around and over a portion of cone 800. Within grooves 1010a-1010n of extraction segments 1000a-1000n is disposed O-ring 1106, which may be a flexible material (e.g., elastic, rubber, plastic, and/or the like). O-ring 1106 may be operable to elastically bind extraction segments 1000a-1000n to one another allowing for controlled transitions between expanded positions and contracted positions. In examples, one or more O-rings may elastically bind all extraction segments 1000a-1000n into a single unitary group. In instances, one or more O-rings elastically bind subsets of extraction segments 1000a-1000n, such that particular extraction segments 1000a-1000n may be selectively transitioned between expanded positions and contracted positions.

A passageway machined within base 804 of cone 800 may be operable to receive fastener 1108 therein. Fastener 1108 may traverse passageways of cone 800, bearing 1104, head 500, and attaching portion 408 of main rod 400. In examples, fastener 1108 is a screw, bolt, and/or the like, such that a distal portion (not shown) of fastener 1108 couples with holding mechanism 600, for example, via a threaded distal end (not shown) of fastener 1108 that screws into a threaded passageway 610 of holding mechanism 600.

In examples, cone 800 may or may not include the above mentioned passageway. In instances, cone 800 may include an integrated protrusion (not shown). The integrated protrusion may extend away from base 804. In examples, fastener 1108 may be omitted, and the integrated protrusion of cone 800 may traverse passageways bearing 1104, head 500, and attaching portion 408 of main rod 400. In examples, the integrated protrusion may be threaded at a distal portion (not shown), which is opposite base 804 of cone 800. The integrated protrusion may couple with holding mechanism 600, for example, via a threaded distal end (not shown) that screws into a threaded passageway 610 of holding mechanism 600.

In instances, passageway 610 of holding mechanism 600 receives a distal portion (not shown) of actuating rod 700 into a first portion of passageway 610 (e.g., actuating rod 700 screws partially through passageway 610) and receives fastener 1108 or integrated protrusion into a second (e.g., opposing) portion of passageway 610 (e.g., fastener 1108 screws partially through passageway 610), such that passageway 610 couples both actuating rod 700 and fastener 1108/integrated protrusion). Alternatively, or additionally, holding mechanism 600 may include a plurality of passageways, such that, actuating rod 700 and fastener 1108/integrated protrusion may couple to holding mechanism 600 via separate passageways, if desired.

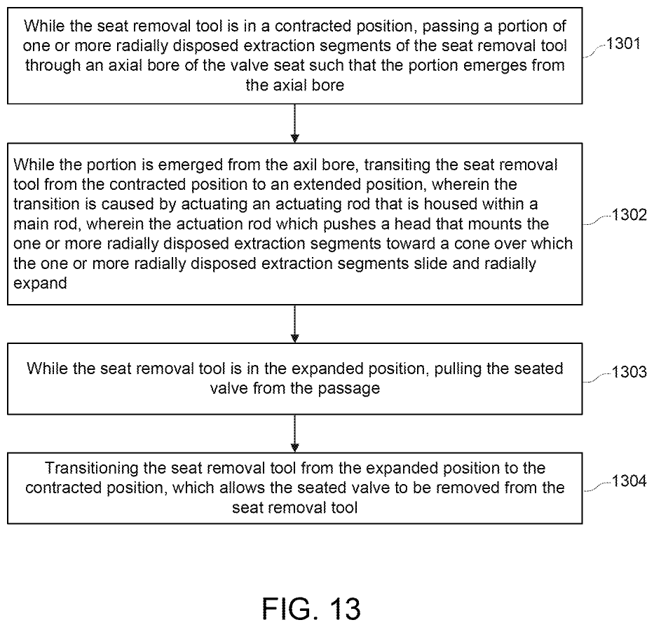

FIG. 13 is a block diagram of an example method of removing a valve seat of a passage via a seat removal tool. In some examples, systems and methods herein may relocate, reposition, and/or otherwise adjust a valve seat. In examples, while the seat removal tool is in a contracted position, operation 1301 passes a portion of one or more radially disposed extraction segments of the seat removal tool through an axial bore of the valve seat such that the portion emerges from the axial bore. In instances, while the portion is emerged from the axil bore, operation 1302 transitions the seat removal tool from the contracted position to an extended position. In some examples, the transition is caused by actuating an actuating rod that is housed within a main rod and the actuation rod pushes a head that mounts the one or more radially disposed extraction segments toward a cone over which the one or more radially disposed extraction segments slide and radially expand. While the seat removal tool is in the expanded position, operation 1303 pulls the seated valve from the passage. In exemplars, operation 1304 transitions the seat removal tool from the extended position to the contracted position, which allows the seated valve to be removed from the seat removal tool. Further, methods may involve controlling at least some of the passing and at least some of the pulling via a pancake jack.

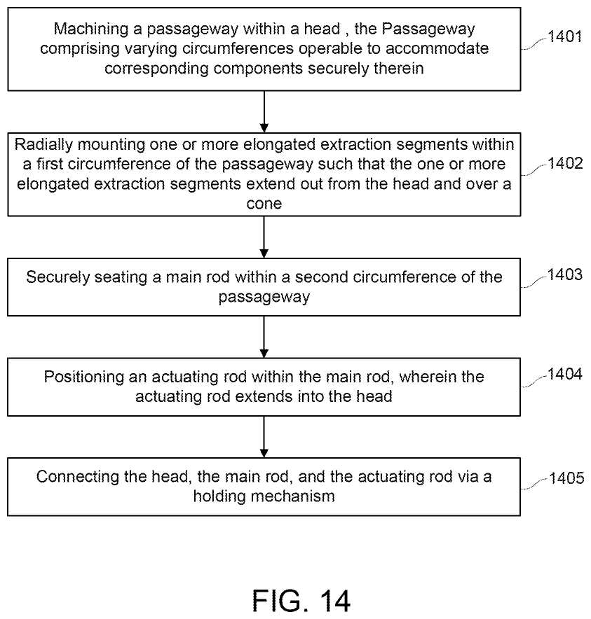

FIG. 14 is a block diagram of an example method of manufacturing a seat removal tool. In examples, operation 1401 machines a passageway within a head, the passageway comprising varying circumferences operable to accomodate corresponding components securely therein. Further, example operation 1402 radially mounts one or more elongated extraction segments within a first circumference of the passageway such that the one or more elongated extraction segments extend out from the head and over a cone. In some examples, operation 1403 securely seats a main rod within a second circumference of the passageway, and operation 1404 positions an actuating rod within the main rod, wherein the actuating rod extends into the head. Further, example operation 1405 connects the head, the main rod, and the actuating rod via a holding mechanism. In instances, example methods of manufacturing a seat removal tool include the head having the one or more elongated extraction segments modularly mounted therein, wherein a first modular head is mounted with one or more elongated extraction segments of a first length that accommodates a first range of valve seats and a second modular head is mounted with one or more elongated extraction segments of a different length that accommodates a different range of valve seats.

The examples illustrated and described herein as well as examples not specifically described herein but within the scope of aspects of the disclosure constitute an exemplary seat removal tool. The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

Although the terms “step” and/or “block” may be used herein to connote different elements of methods employed, the terms should not be interpreted as implying any particular order among or between various steps herein disclosed unless and except when the order of individual steps is explicitly described. The order of execution or performance of the operations in examples of the disclosure illustrated and described herein is not essential, unless otherwise specified. The operations may be performed in any order, unless otherwise specified, and examples of the disclosure may include additional or fewer operations than those disclosed herein. It is therefore contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. For example, in this specification, the word “comprising” is to be understood in its “expanded” sense, that is, in the sense of “including,” and thus not limited to its “closed” sense, that is the sense of “consisting only of.” A corresponding meaning is to be attributed to the corresponding words “comprise,” “comprised,” “comprises,” “having,” “has,” “includes,” and “including” where they appear.

The term “exemplary” is intended to mean “an example of” The phrase “one or more of the following: A, B, and C” means “at least one of A and/or at least one of B and/or at least one of C.” Moreover, in the following claims, the terms “first,” “second,” “third,” and “fourth,” etc. are used merely as labels, and are not intended to impose numerical requirements on their objects.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A seat removal tool, comprising:
an actuator;
a main rod;
an actuating rod positioned within the main rod and coupled to the actuator;
a contracting seat puller head coupled to the actuating rod;
one or more radially positioned extraction segments that are movable, through actuation of the actuator, between a contracted position and an expanded position; and
a cone coupled for selectively expanding the one or more radially positioned extraction segments upon actuation of the actuator.

2. The seat removable tool of claim 1 further comprising:
a holding mechanism, which connects the actuating rod, the main rod, and the contracting seat puller head.

3. The seat removal tool of claim 2 further comprising:
a fastener extending through a passageway of the cone, the contracting seat puller head, and the main rod, wherein the fastener connects to the holding mechanism.

4. The seat removal tool of claim 1, wherein the contracting seat puller head comprises:
an inner passageway of variable circumferences operable to seat at least the main rod and the radially positioned extraction segments.

5. The seat removal tool of claim 1 further comprising:
one or more springs.

6. The seat removal tool of claim 1 further comprising:
a ring comprising grooves and ridges that mounts with opposing grooves and ridges of the one or more radially positioned extraction segments.

7. The seat removal tool of claim 1 further comprising:
at least one O-ring elastically binding at least some of the one or more radially positioned extraction segments.

8. The seat removal tool of claim 1 further comprising:
one or more threaded segments on an exterior portion of the main rod.

9. The seat removal tool of claim 8, wherein the one or more threaded segments correspond to threads of a pancake jack.

10. The seat removal tool of claim 1, wherein the expanded position is one of a plurality of expanded positions of which the one or more radially positioned extraction segments are moveable between.

11. The seat removal tool of claim 10, wherein the expanded position of the plurality of expanded positions is selectable.

12. The seat removal tool of claim 1, wherein a modular portion comprises the contracting seat puller head, the one or more radially positioned extraction segments, and the cone, wherein the modular portion accommodates a selected range of valve seats, and wherein the modular portion is selectively attached to the main rod.

13. The seat removal tool of claim 1, wherein the one or more radially positioned extraction segments are disposed in a plurality of rings, wherein a first ring is located a greater distal distance from the actuator as compared to a second ring.

14. The seat removal tool of claim 13, wherein a contracted position of the first ring is narrower than a contracted position of the second ring.

15. The seat removal tool of claim 13, wherein a length of the main rod and the actuating rod is modular.

16. A method of removing a valve seat of a passage via a seat removal tool, the method comprising:
while the seat removal tool is in a contracted position, passing a portion of one or more radially disposed extraction segments of the seat removal tool through an axial bore of the valve seat such that the portion emerges from the axial bore;
while the portion is emerged from an axil bore, transition the seat removal tool from the contracted position to an extended position, wherein the transition is caused by actuating an actuating rod that is housed within a main rod, wherein the actuation rod which pushes a head that mounts the one or more radially disposed extraction segments toward a cone over which the one or more radially disposed extraction segments slide and radially expand; and
while the seat removal tool is in the expanded position, pulling the seated valve from the passage.

17. The method of claim 16 further comprises:
transitioning the seat removal tool from the extended position to the contracted position, which allows the seated valve to be removed from the seat removal tool.

18. The method of claim 16 further comprises:
controlling at least some of the passing and at least some of the pulling via a pancake jack.

19. A method of manufacturing a seat removal tool, comprising:
machining a passageway within a head, the passageway comprising varying circumferences operable to accomodate corresponding components securely therein;
radially mounting one or more elongated extraction segments within a first circumference of the passageway such that the one or more elongated extraction segments extend out from the head and over a cone;
securely seating a main rod within a second circumference of the passageway;
positioning an actuating rod within the main rod, wherein the actuating rod extends into the head; and
connecting the head, the main rod, and the actuating rod via a holding mechanism.

20. The method of claim 19, wherein the head having the one or more elongated extraction segments mounted therein is modular, wherein a first modular head is mounted with one or more elongated extraction segments of a first length that accommodates a first range of valve seats and a second modular head is mounted with one or more elongated extraction segments of a different length that accommodates a different range of valve seats.
